(19) United States
(12) Patent Application Publication
(10) Pub. No.: US 2009/0029224 A1
(43) Pub. Date: Jan. 29, 2009

(54) LIQUID SEND/RECEIVE JOINT DEVICE AND FUEL CELL SYSTEM USING THE SAME

(75) Inventors: Toru TAKAHASHI, Sagamihara-shi (JP); Nobuo KATSUURA, Yokohama-shi (JP); Junji OYAMA, Sagamihara-shi (JP); Makoto EBIKAWA, Sagamihara-shi (JP); Takuji MAYUZUMI, Sagamihara-shi (JP)

Correspondence Address: NIXON PEABODY, LLP, 401 9TH STREET, NW, SUITE 900, WASHINGTON, DC, 20004-2128, US

(73) Assignee: NIX, INC., Yokohama-shi (JP)

(21) Appl. No.: 11/933,706

(22) Filed: Nov. 1, 2007

(30) Foreign Application Priority Data
Nov. 1, 2006 (JP) 2006-297302

(51) Int. Cl. H01M 2/10

(52) U.S. Cl. 429/34

(57) ABSTRACT

A liquid send/receive joint device that has a simplified configuration, is composed of a small number of components, is of small size, and can be manufactured at low cost and prevent liquid leakage, is provided; and a fuel cell system equipped with such a liquid send/receive joint device is also provided.

The liquid send/receive joint device includes: a first joint member 10 that includes a first housing 15 having a first liquid passage, and a first valve element 20 placed in the first housing 15 so that the first valve element 20 can move within the first housing 15, that movement causing the first liquid passage to be opened or closed; a second joint member 50 that includes a second housing 55 having a second liquid passage, a second valve element 60 placed in the second housing 55 so that the second valve element 60 can move within the second housing 55, that movement causing the second liquid passage to be opened or closed, and a seal member 70 placed between the second housing 55 and the second valve element 60; wherein when the seal member 70 elastically changes its shape, the second valve element 60 pressed by the first housing 15 opens the second liquid passage, and part of the second valve element 60 extends from the seal member 70 toward the first joint member 10, presses the first valve element 20, and then opens the first liquid passage, thereby connecting the first liquid passage with the second liquid passage to enable the liquid to flow between them.

### CROSS-REFERENCES TO RELATED APPLICATIONS

This application relates to and claims priority from Japanese Patent Application No. 2006-297302, filed on Nov. 1, 2006, the entire disclosure of which is incorporated herein by reference.

### BACKGROUND

1. Field of the Invention

The invention relates to a liquid send/receive joint device that is located between a liquid reservoir and a liquid accepter in a liquid supply means for, for example, a fuel cell or an ink-jet printer, and that guides a liquid contained in the liquid reservoir to the liquid accepter. This invention also relates to a fuel cell system equipped with such a liquid send/receive joint device.

2. Description of Related Art

Various liquid-using equipment, such as inkjet printers, lighters and fuel cells using liquid fuel, and devices for chemical liquid administration for medical treatment, that have a liquid accepter (liquid receiving means) for receiving and containing a liquid supplied externally have been widely used. Also, a liquid reservoir (liquid supply means) in various forms for discharging the liquid contained in the liquid-using equipment is suggested as means for supplying the liquid to the above-described liquid accepter.

The major type of the liquid reservoir is a cartridge type that allows the liquid reservoir itself to be directly replaced with a new one when no liquid is left in the liquid reservoir. The cartridge-type liquid reservoir has the advantages that users can supply the liquid to the liquid accepter easily and very safely without dirtying their hands with the liquid. In particular, this is a very effective liquid supply means where the liquid to be supplied may have an adverse effect on the human body or may severely deteriorate if exposed to air.

Also, the development of fuel cells that generate electric power by using a liquid as fuel is being promoted these days. In particular, many electric-appliance makers are actively promoting the development of direct methanol fuel cells (DMFC), which use methanol as fuel. The DMFCs are expected to be new, next-generation batteries that can be used for, for example, notebook personal computers, various portable electronics, and cell phones. However, in general, methanol has a considerable effect on the human body. If a human inhales methanol, it may damage the central nervous system and cause dizziness and diarrhea. If a human inhales a large amount of methanol or methanol enters their eyes, the methanol may cause an optic nerve disorder and there is a high possibility of loss of sight. Accordingly, methanol is a highly dangerous toxic liquid. Therefore, in order to safely and easily supply fuel to general consumers of DMFCs, a means of supplying methanol to a liquid reservoir using a cartridge, without directly touching the methanol, is considered to be the optimum means, and the development of such a means is being widely promoted. (See, for example, Japanese Patent Application Laid-Open (Kokai) Publication No. 2003-308871, Japanese Patent Application Laid-Open (Kokai) Publication No. H8-12301, and Japanese Patent Application Laid-Open (Kokai) Publication No. 2003-317756).

In order to supply a liquid from the liquid reservoir to the liquid accepter, a liquid send/receive joint device is used, and it sends/receives the liquid by connecting a liquid receiving port for the liquid accepter to a liquid supply port for the liquid reservoir in such a manner that they can be detached from each other whenever necessary (see Japanese Patent Application Laid-Open (Kokai) Publication No. H10-789, Japanese Patent Application Laid-Open (Kokai) Publication No. H8-50042, a Japanese translation of PCT international application (Tokuhyo) No. 2003-528699, Japanese Patent Application Laid-Open (Kokai) Publication No. 2003-266739, a Japanese translation of PCT international application (Tokuhyo) No. 2001-524896, Japanese Patent Application Laid-Open (Kokai) Publication No. 2000-289225, Japanese Patent Application Laid-Open (Kokai) Publication No. H7-68780, Japanese Patent Application Laid-Open (Kokai) Publication No. H5-254138, and Japanese Patent Application Laid-Open (Kokai) Publication No. 2003-331879).

However, conventional liquid send/receive joint devices are composed of very many components and have complicated configurations, so they have limitations when it comes to downsizing and cost reduction. Since they are configured to open valves or similar when sending/receiving (distributing) a liquid, if the internal pressure of the liquid reservoir or the liquid accepter becomes high, the liquid tends to leak easily. Therefore, there is a demand for simplification of the configuration and prevention of liquid leakage under high internal pressure. There is also a strong need for a liquid send/receive joint device that can be smoothly and safely attached to or detached from relevant objects to be connected.

### SUMMARY

The present invention was devised in light of the circumstances described above. It is an object of the invention to provide a liquid send/receive joint device that: is composed of a small number of components because of its simplified configuration, is of small size, can be manufactured at low cost, and can prevent liquid leakage under a wide range of conditions, whether under high or low internal pressure. It is another object of the invention to provide a fuel cell system equipped with such a liquid send/receive joint device.

In order to achieve the above-described objects, a liquid send/receive joint device for connecting a liquid reservoir containing a liquid to a liquid accepter for receiving the liquid from the liquid reservoir is provided according to an aspect of the invention. This liquid send/receive joint device includes: a first joint member placed at either of the liquid reservoir or the liquid accepter; and a second joint member placed at the other of the liquid reservoir and the liquid accepter and that can be connected to the first joint member; wherein the first joint member includes: a first housing having a first liquid passage; and a first valve element placed in the first housing so that the first valve element can move within the first housing, that movement causing the first liquid passage to be opened or closed; wherein the second joint member includes: a second housing having a second liquid passage; a second valve element placed in the second housing so that the second valve element can move within the second housing, that movement causing the second liquid passage to be opened or closed; and a seal member that is placed between the second housing and the second valve element, that seals a space between the second housing and the second valve element when closing the second liquid passage, and that comes into contact with the first housing, elastically changes its shape, and seals a space between the second valve element and the first joint member when connecting the first joint member and the second joint member; and wherein when the seal member elastically changes its shape, the second valve element pressed and moved by the first housing opens the second liquid passage, and part of the second valve element extends from the seal member toward the first joint member, presses and moves the first valve element, and then opens the first liquid passage, thereby connecting the first liquid passage with the second liquid passage to enable the liquid to flow between them.

When the first joint member and the second joint member are connected to each other in the liquid send/receive joint device having the above-described configuration, the first housing moves the second valve element and then opens the second liquid passage and, at the same time, part of the second valve element extends from the seal member toward the first joint member and presses and moves the first valve element and then opens the first liquid passage, thereby connecting the first liquid passage with the second liquid passage to enable the liquid to flow between them. Also, when the first liquid passage and the second liquid passage are connected to each other to enable the liquid to flow between them, the seal member securely seals a space between the second housing and the second valve element and a space between the second valve element and the first joint member. As a result, the configuration can be simplified, the number of components can be reduced, downsizing can be achieved, and liquid leakage can be prevented under a wide range of conditions, whether the internal pressure of the liquid reservoir and the liquid accepter is high or low.

Moreover, the liquid send/receive joint device according to an aspect of the invention can be configured so that when the second housing and the second valve element come into contact with each other via the seal member and close the second liquid passage, a seal face between the second housing and the second valve element is generally perpendicular to the movement direction of the second valve element. As a result of the above-described configuration, a large seal area can be obtained; and since the movement of the second valve element causes the seal member to be pressed against the seal face of the second housing, the space between the second housing and the second valve element can be sealed with more certainty.

Furthermore, in the liquid send/receive joint device according to an aspect of the invention, at least either the first housing or the second housing can be made of a material that is more rigid than the material for the seal member. As a result of the above-described configuration, the space between the first housing and the second housing can be sealed stably with more certainty. If both the first housing and the second housing are made of the material that is more rigid than the material for the seal member, the space between the first housing and the second housing can be sealed stably with more certainty. The seal member can be composed of an elastic element (such as one made from rubber and/or elastomer). If elastic elements are made to be in close contact with each other, and if an unnecessary external force is applied to them, there is a possibility that both of them may change their shape and it may become difficult to keep them in stably close contact with each other. On the other hand, if a rigid element and an elastic element are made to be in close contact with each other, even if an unnecessary external force is applied to them, the rigid element supports the elastic element and they can maintain their shape. Therefore, the rigid element and the elastic element can be kept in stably close contact with each other.

In the liquid send/receive joint device according to an aspect of the invention, the first joint member can be placed at the liquid reservoir, and the second joint member can be placed at the liquid accepter. In this case, the liquid send/receive joint device is configured so that the first liquid passage is opened after the second liquid passage is opened. Accordingly, when the first joint member and the second joint member are connected to each other and the liquid is supplied from the liquid reservoir to the liquid accepter, the liquid-accepter-side liquid passage (the second liquid passage) is first opened; and when the preparations for receiving the liquid are complete, the liquid-reservoir-side liquid passage (the first liquid passage) is opened, and the liquid is then supplied. Therefore, in addition to the advantageous effects described earlier, it is possible to prevent liquid leakage from between the first joint member and the second joint member when they are connected to each other.

Also, the liquid send/receive joint device according to an aspect of the invention can be configured so that a first force-applying member that applies force to the first valve element and thereby causes the first valve element make the movement is placed in the first housing, and a second force-applying member that applies force to the second valve element and thereby causes the second valve element to make the movement is placed in the second housing. In this configuration, the first joint member can be placed at the liquid reservoir, the second joint member can be placed at the liquid accepter, and the force applied by the first force-applying member can be larger than the force applied by the second force-applying member. Accordingly, when the first joint member and the second joint member are connected to each other and the liquid is supplied from the liquid reservoir to the liquid accepter, the liquid-accepter-side liquid passage (the second liquid passage) is first opened; and then the liquid-reservoir-side liquid passage (the first liquid passage) is opened. Therefore, it is possible to prevent liquid leakage from between the first joint member and the second joint member when they are connected to each other.

Moreover, the first joint member and the second joint member can be connected to each other in a snap-fit manner so that they can be detached from each other whenever necessary. Also, the liquid send/receive joint device can be configured so that when the first joint member is placed at the liquid reservoir and the second joint member is placed at the liquid accepter, and when the first joint member and the second joint member are connected to each other, at least part of the first housing is placed in the second housing. As a result, in addition to the aforementioned advantageous effects, the first joint member and the second joint member can be connected in a more stable state.

Moreover, an example of the configuration in which the first joint member and the second joint member are connected to each other in a snap-fit manner so that they can be detached whenever necessary is one where a first engagement part is formed on the first joint member, and a second engagement part for engaging with the first engagement part so that the second engagement part can be detached from the first engagement part whenever necessary is formed on the second joint member, and the first engagement part and the second engagement part are made to engage with each other or to release their engagement. Specifically speaking, in this situation, the first engagement part and the second engagement part constitute a snap-fit mechanism; and the first engagement part and the second engagement part can have a false connection prevention key (mechanical key for prevention of false insertion) function that enables centering (positioning) of the first joint member and the second joint member and also enables engagement between the first joint member and the second joint member only if the combination of the first joint member and the second joint member is correct. As a result, it is possible to prevent the unacceptable liquid from being supplied from the unacceptable liquid reservoir to the liquid accepter.

Moreover, when the first joint member is placed at the liquid reservoir and the second joint member is placed at the liquid accepter, and when the first joint member and the second joint member are connected to each other in a snap-fit manner so that they can be detached whenever necessary, the first joint member can have a child-proof function that prevents a malfunction by forming a cover preventing a child from mistakenly touching the exposed portion of the first valve element with their bare hands.

As described above, the liquid send/receive joint device according to an aspect of the invention can be configured so that it has the snap-fit mechanism with the false connection prevention key (mechanical key for false insertion prevention), and also the child-proof function can be added to the first joint member placed at the liquid reservoir.

According to another aspect of the invention, a fuel cell system that includes: a fuel cell; a liquid reservoir containing liquid fuel; a liquid accepter for receiving the liquid fuel from the liquid reservoir and supplying it to the fuel cell; and the liquid send/receive joint device described above is provided.

Since the fuel cell system having the above-described configuration is equipped with the liquid send/receive joint device having the aforementioned advantageous effects, the configuration can be simplified, the number of components can be reduced, downsizing can be achieved, and liquid leakage can be prevented under a wide range of conditions, whether the internal pressure of the liquid reservoir and the liquid accepter is high or low. Incidentally, there is no particular limitation on the type of the liquid fuel, but the liquid fuel can contain methanol.

The liquid send/receive joint device according to an aspect of the invention is configured so that when connecting the first joint member and the second joint member, the first housing moves the second valve element and thereby opens the second liquid passage and, at the same time, part of the second valve element extends from the seal member toward the first joint member and presses and moves the first valve element and thereby opens the first liquid passage, causing the first liquid passage and the second liquid passage to be connected so as to enable the fluid to flow between them; and the space between the second housing and the second valve element and the space between the second valve element and the first joint member are sealed by the seal member with certainty. As a result, the configuration can be simplified, the number of components can be reduced, downsizing can be achieved, and liquid leakage can be prevented under a wide range of conditions, whether the internal pressure of the liquid reservoir and the liquid accepter is high or low. Therefore, a highly reliable liquid send/receive joint device can be provided.

Also, since the fuel cell system according to another aspect of the invention is equipped with the liquid send/receive joint device having the aforementioned advantageous effects, the configuration can be simplified, the number of components can be reduced, downsizing can be achieved, and liquid leakage can be prevented under a wide range of conditions, whether the internal pressure of the liquid reservoir and the liquid accepter is high or low. As a result, a high-performance and highly reliable fuel cell system can be provided.

### BRIEF DESCRIPTION OF THE DRAWINGS

FIG. 1 is a side view of a liquid send/receive joint device according to an embodiment of the invention before a first joint member and a second joint member are connected to each other.

FIG. 2 is a side view of the liquid send/receive joint device according to the embodiment when the first joint member and the second joint member are connected to each other.

FIG. 3 is a cross-sectional view of the liquid send/receive joint device shown in FIG. 1 as taken along line III-III.

FIG. 4 is a cross-sectional view of the liquid send/receive joint device corresponding to FIG. 3, showing an initial stage of the process in which the first joint member and the second joint member are being connected to each other.

FIG. 5 is a cross-sectional view of the liquid send/receive joint device corresponding to FIG. 3, showing a stage of the process in which the first joint member and the second joint member are connected to each other and a liquid passage for the second joint member is opened.

FIG. 6 is a cross-sectional view of the liquid send/receive joint device corresponding to FIG. 3, showing a stage of the process in which the first joint member and the second joint member are connected to each other and a liquid passage for the first joint member is also opened.

FIG. 7 is a fragmentary side view showing the state where the first joint member shown in FIG. 1 is placed in a housing for the liquid reservoir, and the second joint member is connected to a housing for the liquid accepter.

FIG. 8 is a schematic diagram of a fuel cell system according to an embodiment of the invention.

### DETAILED DESCRIPTION OF PREFERRED EMBODIMENTS

A liquid send/receive joint device according to preferred embodiments of the invention, and a fuel cell system equipped with this liquid send/receive joint device will be described below with reference to the attached drawings. The embodiments described below are for the purpose of describing this invention, but the invention is not limited only to those embodiments. Accordingly, this invention can be utilized in various ways unless those utilizations depart from the gist of the invention.

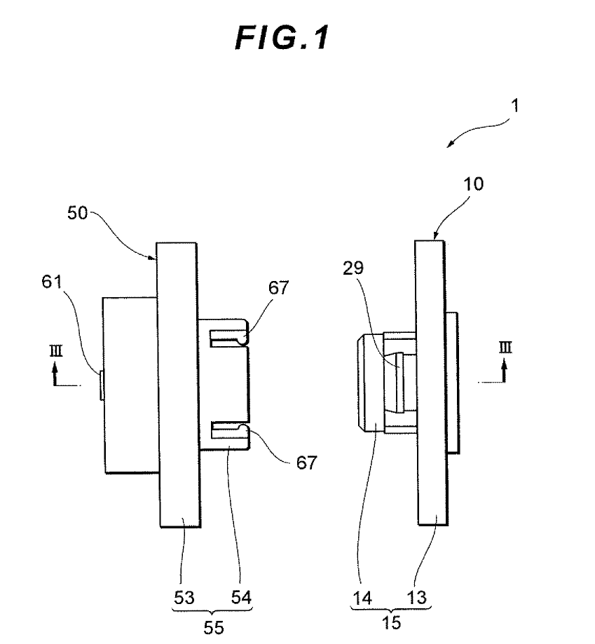

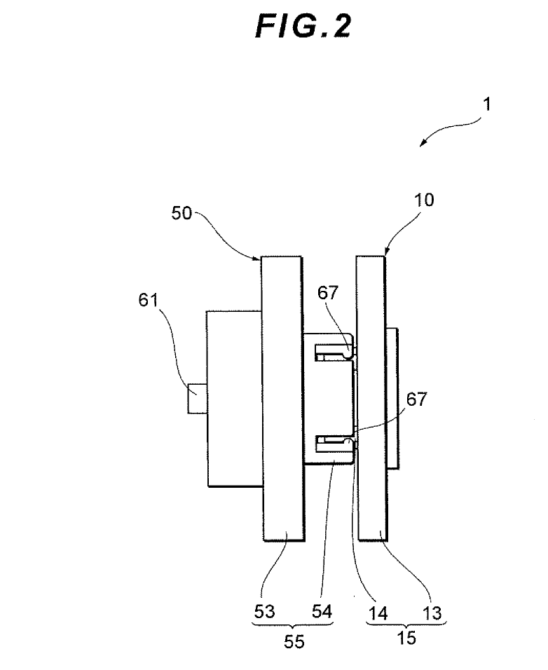

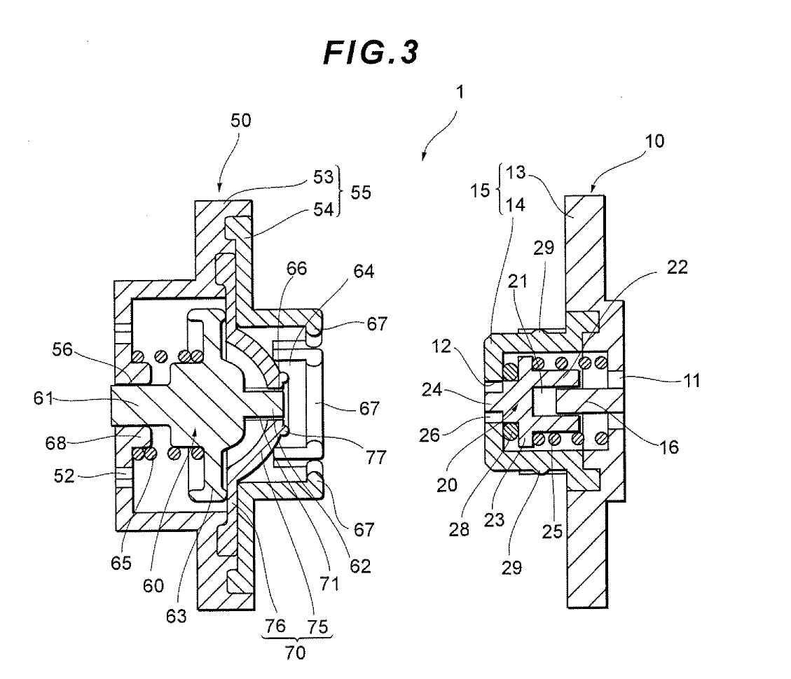

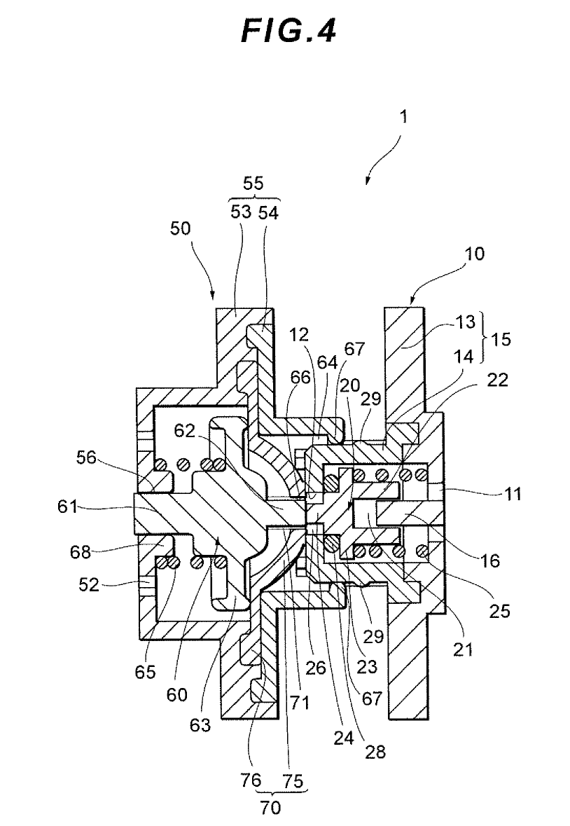

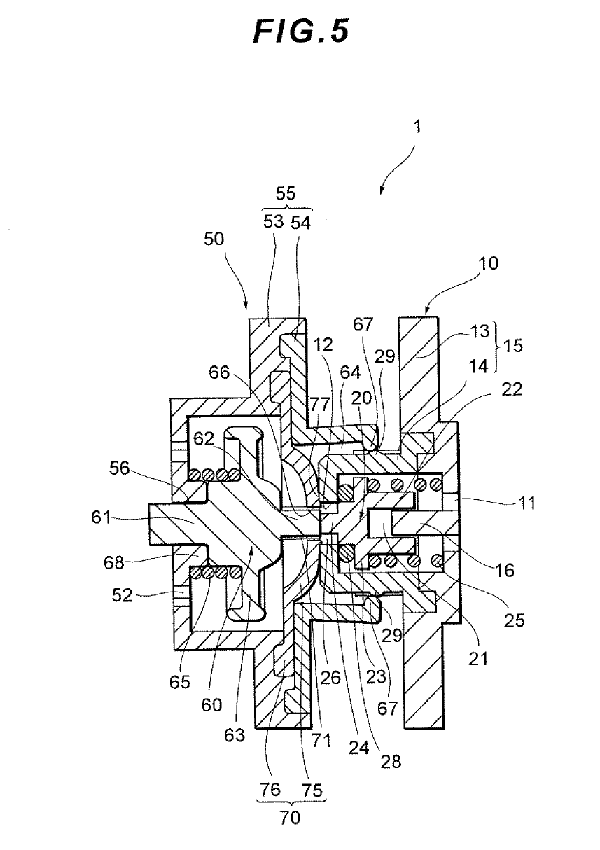

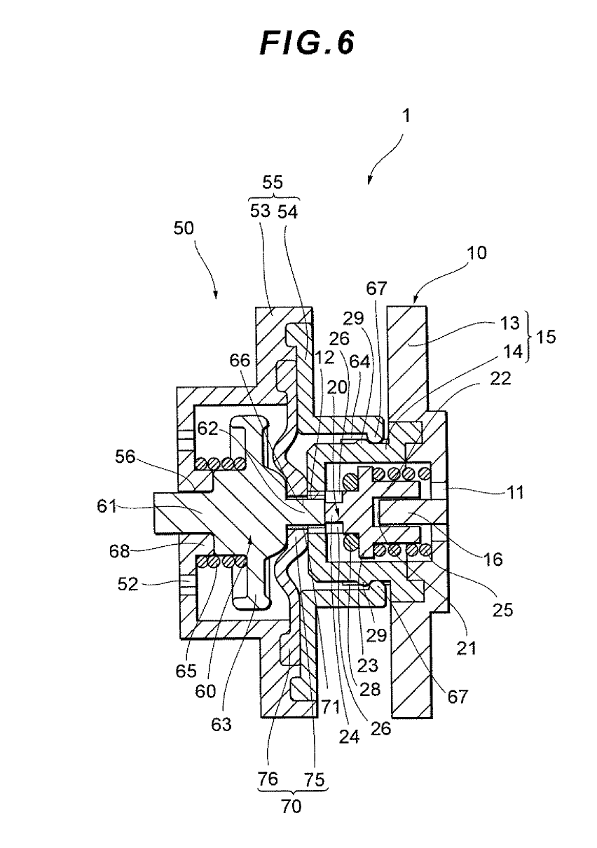

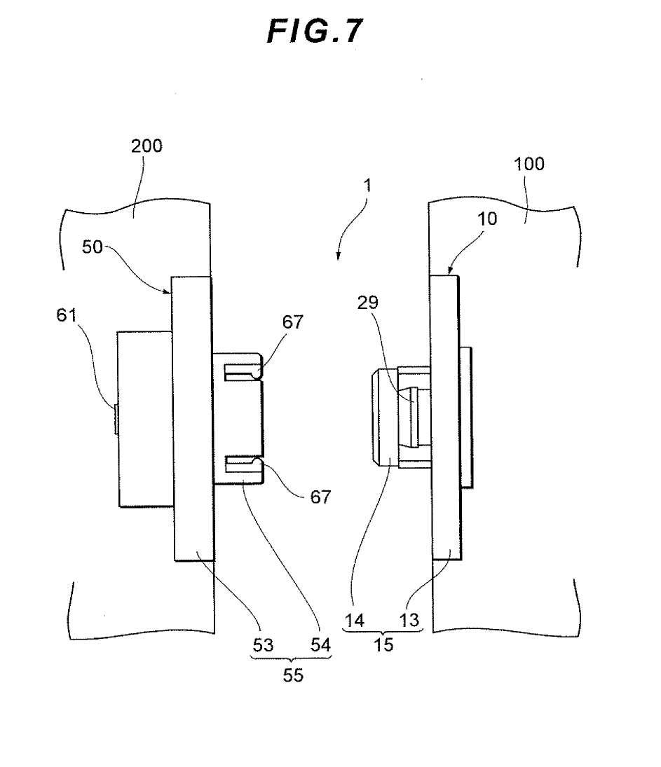

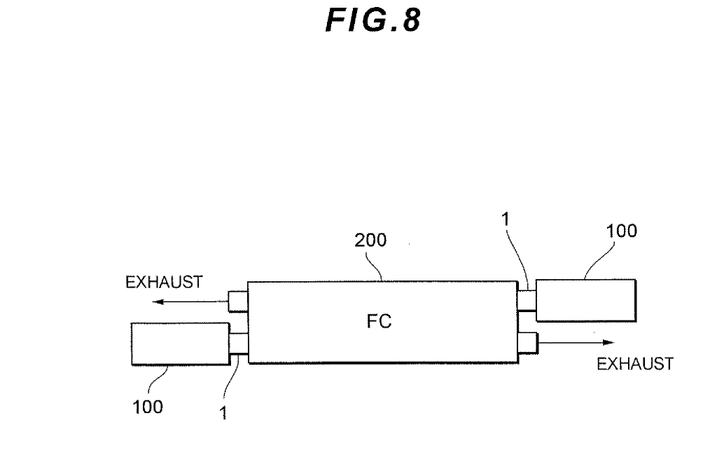

FIG. 1 is a side view of a liquid send/receive joint device according to an embodiment of the invention before a first joint member and a second joint member are connected to each other. FIG. 2 is a side view of the liquid send/receive joint device according to the embodiment when the first joint member and the second joint member are connected to each other. FIG. 3 is a cross-sectional view of the liquid send/receive joint device shown in FIG. 1 as taken along line III-III. FIG. 4 is a cross-sectional view of the liquid send/receive joint device corresponding to FIG. 3, showing an initial stage of the process in which the first joint member and the second joint member are being connected to each other. FIG. 5 is a cross-sectional view of the liquid send/receive joint device corresponding to FIG. 3, showing a stage of the process in which the first joint member and the second joint member are connected to each other and a liquid passage for the second joint member is opened. FIG. 6 is a cross-sectional view of the liquid send/receive joint device corresponding to FIG. 3, showing a stage of the process in which the first joint member and the second joint member are connected to each other and a liquid passage for the first joint member is also opened. FIG. 7 is a fragmentary side view showing the state where the first joint member shown in FIG. 1 is placed in a housing for the liquid reservoir, and the second joint member is connected to a housing for the liquid accepter. FIG. 8 is a schematic diagram of a fuel cell system according to an embodiment of the invention.

As shown in FIGS. 1 to 7, a liquid send/receive joint device 1 according to an embodiment of the invention includes: a first joint member 10 placed in a housing 100 for a liquid reservoir containing a liquid; and a second joint member 50 placed in a housing 200 for a liquid accepter for receiving the liquid supplied from the liquid reservoir. In this liquid send/receive joint device 1, the first joint member 10 placed in the housing 100 is connected with the second joint member 50 placed in the housing 200, thereby connecting the liquid reservoir and the liquid accepter and supplying the liquid contained in the liquid reservoir to the liquid accepter.

There is no particular limitation on the type of the liquid reservoir, and examples of the liquid reservoir include liquid fuel cartridges containing liquid fuel, ink cartridges containing liquid ink, and chemical liquid cartridges containing chemical liquid. Also, there is no particular limitation on the type of the liquid accepter, and examples of the liquid accepter include: equipment such as fuel cells and lighters using liquid fuel supplied from liquid fuel cartridges; equipment such as printers using ink supplied from ink cartridges; and various kinds of medical equipment and laboratory-ware using chemical liquid supplied from chemical liquid cartridges.

If a fuel cell is used as the liquid accepter, the housing 200 for the fuel cell FC and the housing 100 for the liquid accepter containing the liquid fuel may be connected by the liquid send/receive joint device 1 as shown in FIG. 8. In this case, an example of the fuel cell as the liquid accepter is a direct methanol fuel cell (DMFC). The fuel cell includes: an electrolyte membrane made of, for example, perfluoro sulfonate polymer; an anode electrode provided on one side of the electrolyte membrane; a cathode electrode provided on the other side of the electrolyte membrane; and a pair of separators provided to hold both the electrodes between them. In this fuel cell system, fuel (methanol) supplied from a fuel cartridge, which is the liquid reservoir, to the fuel cell, which is the liquid accepter, is supplied to the anode electrode by, for example, a pump. On the other hand, oxygen is supplied to the cathode electrode by sending air from the atmosphere to the cathode electrode. In this case, it is desirable that an air blower mechanism composed of, for example, fans be provided somewhere in a passage to send the air to the cathode electrode. Accordingly, it is possible to increase the oxygen supply as necessary. Methanol and oxygen supplied in this manner generate electric power by means of a chemical reaction. After the chemical reaction, the methanol and oxygen are discharged as water or CO₂ from the fuel cell system.

The first joint member 10 includes: a first housing 15; a first valve element 20 placed in the first housing 15 so that the first valve element 20 can move within the first housing 15; and a first coil spring 25 that is placed in the first housing 15 and applies force to the first valve element 20.

The first housing 15 is made of, for example, plastic and includes: a base 13 to be attached to the housing 100; and a male joint part 14 attached to the base 13.

A supply port 11 for supplying the liquid contained in the liquid reservoir into the first housing 15 is formed at an approximate central area of the base 13. The base 13 also has, at an approximate central position of the supply port 11, a generally-cylindrical stopper 16 that protrudes toward the male joint part 14 and guides and limits the movement of the first valve element 20.

A discharge port 12 for discharging the liquid supplied from the supply port 11 is formed at the top end of the male joint part 14 (on its end face away from the base 13) at a position opposite the supply port 11. Also, four engagement protrusions 29 that can engage respectively with four engagement hooks 67 formed on a female joint part 54 (described later in detail) are formed and equally spaced apart around the outside surface of the male joint part 14. The first valve element 20 is placed in a space defined by the inside wall of the base 13 and the inside wall of the male joint part 14 so that the first valve element 20 can be moved by the first coil spring 25 within the space; and the liquid is contained in that space.

The first valve element 20 includes: a cylindrical part 22 that defines a generally-cylindrical stopper insertion hole 21 into which the stopper 16 is inserted so that the stopper 16 can move back and forth in the stopper insertion hole 21; and a generally-cylindrical pressing part 24 that is provided on the cylindrical part 22 at a position closer to the top-end side of the cylindrical part 22 than the position where a flange 23 is formed, and that is inserted into the discharge port 12 so that the pressing part 24 can move back and forth in the discharge port 12. One end of the first coil spring 25 is fastened to the base 13 side surface of the flange 23, while the other end of the first coil spring 25 is fastened to the base 13. The first valve element 20 is always pressed against the discharge port 12 side by the force applied by the first coil spring 25. In its normal state as shown in FIG. 3, the top end portion of the stopper 16 is inserted into the stopper insertion hole 21, and the pressing part 24 is inserted into the discharge port 12. In this situation, the pressing part 24 does not extend out of the male joint part 14, and the discharge port 12 has a small diameter of, for example, about 1 mm. In this way, the first joint member 10 is designed to prevent anyone (like a child) from touching the first valve element 20 even if that person touches the first joint member 10 (the first joint member 10 is child-proofed). In other words, the end face of the male joint part 14 that defines the discharge port 12 functions as a cover that prevents a person from touching the exposed portion of the first valve element 20. Also, an O-ring 28 is provided on the discharge port 12 side of the flange 23. This O-ring 28 in normal state as shown in FIG. 3 is placed between the discharge port 12 side surface of the flange 23 and the inside wall of the male joint part 14 and seals a space between them, so that the O-ring 28 blocks the first liquid passage extending from the supply port 11 to the discharge port 12. Moreover, a liquid passage 26 for distributing a liquid is formed in the pressing part 24.

The second joint member 50 includes: a second housing 55; a second valve element 60 placed in the second housing 55 so that the second valve element 60 can move within the second housing 55; a second coil spring 65 that is placed in the second housing 55 and applies force to the second valve element 60; and a seal member 70 that seals a space between the second housing 55 and the second valve element 60.

The second housing 55 is made of, for example, plastic and includes: a base 53 attached to the housing 200; and a female joint part 54 attached to the base 53.

A discharge port 52 for discharging the supplied liquid to the liquid accepter is formed in an approximate central area of the base 53. A mounting hole 56 in which one end 61 of the second valve element 60 is mounted and can move back and forth is formed in an approximate central area of the base 53. This mounting hole 56 also serves to guide the back-and-forth movement of the end 61 of the second valve element 60. The inside wall portion of the base 53 that defines the mounting hole 56 is composed of a protrusion 68 that protrudes toward the inside of the second housing 55. When the second valve element 60 (described later in detail) moves to the mounting hole 56 side, the end face of the protrusion 68 comes into contact with the second valve element 60, thereby limiting the movement of the second valve element 60.

The female joint part 54 has, in its approximate central area, a generally-cylindrical recess 64 that can accommodate the male joint part 14. The male joint part 14 side of the side wall defining this recess 64 is divided into four sections that are equally spaced apart; engagement hooks 67 that can engage with the engagement protrusions 29 formed at the male joint part 14 are formed at the top ends of the respective four divided sections. When the first joint member 10 and the second joint member 50 are connected to each other, the male joint part 14 is placed in the female joint part 54, and the engagement hooks 67 engage with the engagement protrusions 29 so that they can be detached from each other whenever necessary. Accordingly, the engagement hooks 67 and the engagement protrusions 29 can be attached to or detached from each other in a snap-fit manner whenever necessary. Therefore, according to this embodiment, the engagement protrusions 29 constitute snap-fit parts of the first joint member 10, the engagement hooks 67 constitute snap-fit parts of the second joint member 50, and the engagement protrusions 29 and the engagement hooks 67 constitute a snap-fit mechanism. Incidentally, the second valve element 60 is placed in a space defined by the inside wall of the base 53 and the inside wall of the female joint part 54 so that the second valve element 60 can be moved by the second coil spring 65 in that space; and the seal member 70 is also placed in that space.

One generally-cylindrical end 61 of the second valve element 60 is placed in the mounting hole 56 formed in the base 53 so that the end 61 can move back and forth in the mounting hole 56; and the other generally-cylindrical end 62 of the second valve element 60 is placed in a mounting hole 66 formed in the seal member 70 (described later in detail) so that the end 62 of the second valve element 60 can move back and forth in the mounting hole 66. A generally-disk-shaped flange 63 is formed between the generally-cylindrical end 61 and the generally-cylindrical end 62. One end of the second coil spring 65 is fastened to the base 53 side of this flange 63, while the other end of the second coil spring 65 is fastened to the base 53. This second valve element 60 is always pressed against the female joint part 54 side by the force applied by the second coil spring 65. Also, a liquid passage 71 for distributing the liquid is formed at the other end 62 of the second valve element 60. Incidentally, in this embodiment, the second coil spring 65, which applies smaller force than the force applied by the first coil spring 25, is used.

The seal member 70 is composed of an elastic element such as one made from rubber and/or elastomers, and includes: a hemispherical part 75 that is located in an approximate central area of the seal member 70 and is of a generally hemispherical shape; and a flange 76 formed around the entire outside surface of the hemispherical part 75. A space is formed between the hemispherical part 75 and the second valve element 60. When the hemispherical part 75 is pressed from outside, it can retreat to the above-described space and thereby change its shape. Also, the mounting hole 66 in which the other end 62 of the second valve element 60 is placed so that the end 62 can move back and forth in the mounting hole 66 is formed in an approximate central area of the hemispherical part 75. A labyrinth seal 77 that protrudes in a generally-ring shape is formed on the surface of the hemispherical part 75 around the periphery of the mounting hole 66. On the other hand, the flange 76 is held between the base 53 and the female joint part 54. This seal member 70 is normally in close contact with the second valve element 60 as shown in FIG. 3, and the seal member 70 seals a space between the second valve element 60 and the inside wall of the female joint part 54 and blocks the second liquid passage extending from the liquid passage 71 to the discharge port 52. The seal face between the second valve element 60 and the seal member 70 is generally perpendicular to the movement direction of the second valve element 60; and the seal face between the inside wall of the female joint part 54 and the seal member 70 is also generally perpendicular to the movement direction of the second valve element 60. As a result, a large seal face area can be obtained; and since the seal member 70 is pressed against the inside wall of the female joint part 54 (the seal face) by the movement of the second valve element 60, the space between the second valve element 60 and the seal member 70 and the space between the inside wall of the female joint part 54 and the second valve element 60 can be sealed with certainty.

Examples of plastics used to form the first housing 15 and the second housing 55 include: polyethylene, polypropylene, polyvinyl chloride resin, polystyrene, ABS resin, methacrylic resin, polyethyleneterephthalate, polyamide, polycarbonate, polyacetal, polybutylene terephthalate, modified polyphenylene ether, polyphenylene sulfide, liquid crystal polymer, polysulfone, polyether sulfone, polyallylate, polyether ether ketone, polyphthal amide, polyimide, polyether-imide, polyamide-imide, polymethyl pentene, fluororesin, polyvinylidene fluoride, TEFE, PFA, phenolic resin, urea resin, melamine resin, unsaturated polyester, diallyl phthalate, epoxy resin, polyurethane resin, and silicon resin. In this embodiment, polypropylene, which is highly resistant to methanol, is used in consideration of the fact that it is used in a DMFC.

As the material for the seal member 70, various known elastic materials such as rubbers and elastomers can be used. Specific examples of the elastic materials include: styrene butadiene rubber, butadiene rubber, syndiotactic 1,2-polybutadiene, isoprene rubber, acrylonitrile-butadiene rubber, chloroprene rubber, ethylene-propylene rubber, ethylene-propylene terpolymer, butyl rubber, acrylic rubber, chlorosulfonated polyethylene, silicon rubber, vinylidene fluoride rubber, tetrafluoroethylene-propylene rubber, tetrafluoroethylene perfluoromethyl vinyl ether rubber, fluorosilicon rubber, epichlorohydrin rubber, polysulfide rubber, urethane rubber, and natural rubber. These rubber types can be used alone, or in combination.

Specific operations of the liquid send/receive joint device 1 according to this embodiment will be described below.

In order to supply the liquid contained in the liquid reservoir, where the first joint member 10 is placed, to the liquid accepter, where the second joint member 50 is placed, the male joint part 14 for the first joint member 10 is first inserted into the female joint part 54 for the second joint member 50 as shown in FIG. 4. At this point in time, centering (positioning) of the male joint part 14 and the female joint part 54 is conducted and they are optimally connected by inserting the male joint part 14 into the female joint part 54 so that the engagement protrusions 29 formed on the male joint part 14 engage with the engagement hooks 67 formed on the second joint member 50. As the male joint part 14 and the seal member 70 are made to come into contact with each other, the space between them is sealed and the top-end face of the pressing part 24 for the first valve element 20 comes into contact with the top-end face of the second valve element 60.

In this embodiment, the seal member 70 is made of, for example, rubber and the male joint part 14 is made of plastic (i.e., a material with higher rigidity than that of the material for the seal member 70). Therefore, sealability can be enhanced compared to the case where two elastic elements are in close contact with each other. Moreover, if a correct liquid reservoir is not selected for the liquid accepter, the engagement protrusions 29 and the engagement hooks 67 do not engage with each other. Therefore, it is possible to prevent the unacceptable liquid from being supplied from the unacceptable liquid reservoir to the liquid accepter. In other words, the engagement protrusions 29 and the engagement hooks 67 (snap-fit mechanism) serve as a false connection prevention key (mechanical key for prevention of false insertion) and engage with each other only when the combination of the first joint member and the second joint member is correct. Regarding the male joint part 14 for the first joint member 10 provided on the liquid reservoir side, the end face of the male joint part 14 that defines the discharge port 12 constitutes a cover that prevents any person from mistakenly touching the exposed portion of the first valve element 20 with their bare hands, the first joint member 10 is also child-proofed.

Next, if the male joint part 14 is further inserted into the female joint part 54, the male joint part 14 presses the seal member 70 and the other generally-cylindrical end 62 of the second valve element 60, the hemispherical part 75 of the seal member 70 begins to be pushed down, and the second valve element 60 moves toward the mounting hole 56 side against the force applied by the second coil spring 65 and comes into contact with the end face of the protrusion 68 as shown in FIG. 5. When the second valve element 60 makes the above-described movement, one end 61 of the second valve element 60 is guided by the inside wall defining the mounting hole 56. As a result, the second valve element 60 can move stably. Also, at this point in time, the hemispherical part 75 is not completely pushed down yet, and there is a space between the hemispherical part 75 and the second valve element 60. The above-described movement causes the second valve element 60 to move away from the flange 76 of the seal member 70 and thereby opens the second liquid passage extending from the liquid passage 71 to the discharge port 52. In this series of movements, the force applied by the second coil spring 65 is smaller than the force applied by the first coil spring 25. Therefore, when the male joint part 14 presses the seal member 70 and the other generally-cylindrical end 62 of the second valve element 60, the second valve element 60 starts moving before the first valve element 20 does. In this way, the preparations on the liquid accepter side where the second joint member 50 is provided, for receiving the liquid are completed.

If the male joint part 14 in the state shown in FIG. 5 is then further inserted into the female joint part 54, the male joint part 14 further presses the seal member 70 and the other generally-cylindrical end 62 of the second valve element 60, and squashes the hemispherical part 75 of the seal member 70, and the end 62 of the second valve element 60 extends out of the mounting hole 66 in the hemispherical part 75 toward the first joint member 10 and enters the first housing 15 through the discharge port 12 formed in the male joint part 14, and presses the first valve element 20 as shown in FIG. 6. The above-described movement causes the first valve element 20 to move toward the supply port 11 side against the force applied by the first coil spring 25, and to also move away from the male joint part 14, thereby opening the first liquid passage extending from the supply port 11 to the discharge port 12. When the first valve element 20 makes the above-described movement, the first valve element 20 is guided by the stopper 16 inserted in the stopper insertion hole 21. As a result, the first valve element 20 can move stably.

As a result of the above-described operations, the first liquid passage and the second liquid passage are connected to each other to enable the liquid to flow between them, and the liquid contained in the liquid reservoir is supplied via the liquid send/receive joint device 1 to the liquid accepter. Since the second liquid passage leading to the liquid accepter is first opened and then the first liquid passage leading to the liquid reservoir is opened as described above, liquid leakage between the first joint member 10 and the second joint member 50 can be prevented when they are connected to each other. Also, since the first joint member 10 and the second joint member 50 are connected to each other in a snap-fit manner, the liquid can be supplied stably and the space between the first joint member 10 and the second joint member 50 is sealed by the close contact between the seal member 70 and the male joint part 14. Since the labyrinth seal 77 is formed on the seal member 70, and the seal member 70 and the male joint part 14—which is made of the material with higher rigidity than the material for the seal member 70—are in close contact with each other, the space between the first joint member 10 and the second joint member 50 is sealed with certainty.

In order to finish supplying the liquid from the liquid reservoir to the liquid accepter later, it is only necessary to remove the first joint member 10 from the second joint member 50. Since the first joint member 10 and the second joint member 50 are connected to each other in a snap-fit manner, the first joint member 10 can be removed from the second joint member 50 easily. Once the first joint member 10 is removed from the second joint member 50, the force applied by the first coil spring 25 causes the first valve element 20 to move toward the discharge port 12, and the first valve element 20 comes into close contact with the inside wall of the male joint part 14 via the O-ring 28, thereby blocking the first liquid passage extending from the supply port 11 to the discharge port 12. Subsequently, the seal member 70 elastically returns to its original state, and the force applied by the second coil spring 65 moves the second valve element 60 toward the seal member 70 and makes the second valve element 60 closely contact the seal member 70, thereby closing the second liquid passage extending from the liquid passage 71 to the discharge port 52. Since the first liquid passage leading to the liquid reservoir is closed first and then the second liquid passage leading to the liquid accepter is closed, it is possible to prevent liquid leakage from between the first joint member 10 and the second joint member 50 when they are disconnected.

This embodiment described the case where the first joint member 10 is placed in the housing 100 for the liquid reservoir and the second joint member 50 is placed in the housing 200 for the liquid accepter. However, the configuration of the invention is not limited to this example, and the first joint member 10 may be placed in the housing 200 for the liquid accepter and the second joint member 50 may be placed in the housing 100 for the liquid reservoir if desired. In this case, in order to more reliably prevent liquid leakage from between the first joint member 10 and the second joint member 50 when they are connected, it is desirable that the force applied by the first coil spring 25 be smaller than the force applied by the second coil spring 65 and the second liquid passage leading to the liquid reservoir be opened after the first liquid passage leading to the liquid accepter is opened.

Also, this embodiment described the case where the first housing 15 is composed of the base 13 and the male joint part 14. However, the configuration of the first housing 15 is not limited to this example, and the base 13 and the male joint part 14 may be integrally formed as the first housing 15 as long as the first housing 15 has the first liquid passage and can contain the first valve element 20.

Furthermore, this embodiment described the case where the second housing 55 is composed of the base 53 and the female joint part 54. However, the configuration of the second housing 55 is not limited to this example, and the base 53 and the female joint part 54 may be integrally formed as the second housing 55 as long as the second housing 55 has the second liquid passage and can contain the second valve element 60.

This embodiment described the case where the seal member 70 is composed of the hemispherical part 75 and the flange 76. However, other configurations may be employed for the seal member 70 as long as the seal member 70 is placed between the second housing 55 and the second valve element 60 and can seal the space between the second housing 55 and the second valve element 60 when closing the second liquid passage; and the seal member 70 can come into contact with the male joint part 14, elastically change its shape, and seal the space between the second valve element 60 and the male joint part 14 when the first joint member 10 and the second joint member 50 are connected to each other.

What is claimed is:

1. A liquid send/receive joint device for connecting a liquid reservoir containing a liquid to a liquid accepter for receiving the liquid from the liquid reservoir, the liquid send/receive joint device comprising:
a first joint member placed at either of the liquid reservoir or the liquid accepter; and
a second joint member placed at the other of the liquid reservoir and the liquid accepter and that can be connected to the first joint member;
wherein the first joint member includes:
a first housing having a first liquid passage; and
a first valve element placed in the first housing so that the first valve element can move within the first housing, that movement causing the first liquid passage to be opened or closed;
wherein the second joint member includes:
a second housing having a second liquid passage;
a second valve element placed in the second housing so that the second valve element can move within the second housing, that movement causing the second liquid passage to be opened or closed; and
a seal member that is placed between the second housing and the second valve element, that seals a space between the second housing and the second valve element when closing the second liquid passage, and that comes into contact with the first housing, elastically changes its shape, and seals a space between the second valve element and the first joint member when connecting the first joint member and the second joint member; and
wherein when the seal member elastically changes its shape, the second valve element pressed and moved by the first housing opens the second liquid passage, and part of the second valve element extends from the seal member toward the first joint member, presses and moves the first valve element, and then opens the first liquid passage, thereby connecting the first liquid passage with the second liquid passage to enable the liquid to flow between them.

2. The liquid send/receive joint device according to claim 1, wherein when the second housing and the second valve element close the second liquid passage, a seal face between the second housing and the second valve element is generally perpendicular to the movement direction of the second valve element.

3. The liquid send/receive joint device according to claim 1, wherein at least either the first housing or the second housing is made of a material that is more rigid than the material for the seal member.

4. The liquid send/receive joint device according to claim 1, wherein the first joint member is placed at the liquid reservoir, the second joint member is placed at the liquid accepter, and the first liquid passage is opened after the second liquid passage is opened.

5. The liquid send/receive joint device according to claim 1, wherein a first force-applying member that applies force to the first valve element and thereby causes the first valve element make the movement is placed in the first housing, and a second force-applying member that applies force to the second valve element and thereby causes the second valve element to make the movement is placed in the second housing.

6. The liquid send/receive joint device according to claim 5, wherein the first joint member is placed at the liquid reservoir, the second joint member is placed at the liquid accepter, and the force applied by the first force-applying member is larger than the force applied by the second force-applying member.

7. The liquid send/receive joint device according to claim 1, wherein the first joint member is placed at the liquid reservoir, the second joint member is placed at the liquid accepter; and the first joint member and the second joint member are connected to each other in a snap-fit manner so that they can be detached from each other whenever necessary; and when the first joint member and the second joint member are connected to each other, at least part of the first housing is placed in the second housing.

8. A fuel cell system comprising:
a fuel cell;
a liquid reservoir containing liquid fuel;
a liquid accepter for receiving the liquid fuel from the liquid reservoir and supplying it to the fuel cell; and
the liquid send/receive joint device described in any one of claims 1 to 7.

9. The fuel cell system according to claim 8, wherein the liquid fuel contains methanol.
